(19) United States
(12) Patent Application Publication
(10) Pub. No.: US 2015/0308036 A1
(43) Pub. Date: Oct. 29, 2015

(54) Detection Of A Periodic Structure In A Moving Elongated Textile Material

(71) Applicant: USTER TECHNOLOGIES AG, Uster (CH)

(72) Inventors: Rafael Storz, Kreuzlingen (CH); Peter Pirani, Grut (CH)

(73) Assignee: Uster Technologies,, Uster (CH)

(21) Appl. No.: 14/647,581

(22) PCT Filed: Dec. 2, 2013
(86) PCT No.: PCT/CH2013/000210

§ 371 Date: May 27, 2015

(30) Foreign Application Priority Data
Dec. 10, 2012 (CH) 2740/12

(51) Int. Cl. D06H 3/08; G01N 21/892; G01N 21/89

(52) U.S. Cl. CPC D06H 3/08; G01N 21/8914; G01N 21/8922

(57) ABSTRACT

In the method for detecting a periodic structure in a moving elongated textile material, the textile material is scanned simultaneously at several detection points which are arranged in an equidistant manner along its longitudinal direction. Scanning signals detected at the detection points are added to form a composite signal. As a result of temporal changes in the composite signal, conclusions are drawn on the periodic structure of the textile material. A spatial spectrum of the structure of the textile material can be obtained practically without any computational effort in several groups of several respective equidistant detection points.

### BACKGROUND OF THE INVENTION

The present invention lies in the field of textile material testing. It relates to a method and a device for detecting a periodic structure in a moving elongated textile material, according to the preambles of the independent claims. The invention can be used for example in yarn testing devices in the textile laboratory or in yarn clearers on spinning or winding machines.

### DESCRIPTION OF THE PRIOR ART

A large number of different methods and devices for testing textile materials are known. Different sensor principles are used in the textile testing devices. The present invention uses the optical sensor principle, which is known from WO-2004/044579 A1 for example. The textile material is illuminated by a light source and light interacting with the textile material is detected by light detectors. The detected light is a measure for the diameter of the textile material and/or its optical properties such as reflectivity or color.

Some devices known from the prior art use optoelectronic sensor arrays in order to measure a transverse dimension of the textile material by means of shadowing by the textile material. The sensor arrays per se are mostly arranged in CMOS or CCD technology and are available on the market. Examples for such optical textile measuring devices are disclosed in the specifications CH-643′060 A5, EP-0′971′204 A2 and WO-99/36746 A1.

A method and a device for the detection of defects in moving textile materials are known from WO-89/01147 A1. A rectangle is illuminated on the material and projected by means of anamorphic imaging to a line or matrix sensor. In this process, the light originating from a specific region in a direction of movement of the material is optically integrated. Defects in the material are more conspicuous in the integration signal and can thus be better recognized.

In order to detect periodic yarn defects, a time-dependent output signal of a yarn sensor is usually transformed by means of Fourier transform into the time frequency domain. The frequencies represented in the time frequency domain with large amplitudes indicate periodic yarn defects, whereas the amplitudes of the other frequencies are a measure for aperiodic yarn irregularity. Examples for methods which apply the Fourier transform are provided in the specifications U.S. Pat. No. 2,950,435 A, U.S. Pat. No. 5,592,849 A and EP-2′090′538 A2. The calculation of the Fourier transform is work-intensive, irrespective of whether it is performed in an analog or digital manner.

EP-1′553′037 A1 discloses a device for the measurement of speed of a running yarn. The device comprises several light receivers which are arranged in an equidistant manner in the running direction of the yarn. The yarn is illuminated in transmission, so that its shadow falls on the light receiver. Irregularities inherently present in the yarn such as fibers generate temporally changing signals in the light receivers. The signals of the individual light receivers are added to form a composite signal. The yarn speed is obtained from the multiplication of the time frequency dominating in the composite signal with the equidistance of the light receivers.

DE-36′28′654 C2 describes a method for determining the length disparity of the single yarn components of a running thread. The thread structure is optically scanned transversely to the direction of movement. The scanning signal is subjected to frequency analysis. If all single yarns that constitute the thread have the same length, the scanning signal contains a single frequency component with a specific fundamental frequency. In the case of single yarns of different length, subharmonics of the fundamental frequency also occur in the scanning signal.

Circuit boards with optical waveguide structures and electrical conductor structures are generally known, e.g. from US-2010/0209854 A1.

### SUMMARY OF THE INVENTION

It is an object of the present invention to provide a method and a device for detecting a periodic structure in a moving elongated textile material, by means of which the periodic structure can be recognized in a simpler and quicker way than in the state of the art. If possible, the periodic structure shall also be quantifiable.

These and other objects are achieved by the method in accordance with the invention and the device in accordance with the invention, as defined in the independent claims. Advantageous embodiments are provided in the dependent claims.

The theoretical background of the invention is the system theory for linear systems. The invention is based on the idea that the textile material is scanned at several discrete detection points which are arranged in an equidistant manner along its longitudinal direction and conclusions are drawn on a periodic structure of the textile material from a composite signal of the detection points. If several such groups of detection points with different equidistances are made available, a spatial spectrum of the structure of the textile material can be gained from the composite signals. In other words, a Fourier transform of the structure of the textile material can be generated by the invention with practically no computational effort.

The detection points are the positions where the textile material is scanned directly. They are situated as close as possible to the textile material or its intended path in order to achieve high signal-to-noise ratio and high local resolution. The distance between the textile material and a detection point preferably lies between 0.1 mm and a few millimeters. Elements are attached to the detection points which are designated for recording physical signals which contain information on the textile material. The physical signals can be transmitted for example by electromagnetic fields. In a preferred embodiment, ends of optical waveguides are situated close to the detection points, and measuring electrodes in another embodiment.

A technology which is especially suitable for the implementation of the invention is an optical waveguide structure integrated on a substrate. Firstly, this allows a dense linear arrangement of many discrete detection points in a scanning region. The smallest equidistance of the detection points should not exceed the smallest spatial period to be detected in the textile material, and the length of the scanning region should at least be as large as the greatest spatial period to be detected. Equidistances in the submillimeter range are possible over lengths of several centimeters with integrated-optical waveguide structures. As a result, an interesting region of the spatial periods expected in conventional textile material such as yarns is thus covered. Secondly, waveguide junctions can be realized with the integrated-optical waveguide structure, by means of which the light fractions detected at several detection points can be combined, so that after the combination an optical composite signal is obtained. The expressions such as “optical composite signal” or “addition of light fractions” mean in the present specification the sum total or addition of the individual light intensities.

In the method in accordance with the invention for detecting a periodic structure in a moving elongated textile material, the textile material is thus scanned simultaneously at several discrete detection points which are arranged along its longitudinal direction and are spaced in an equidistant manner from each other, scanning signals detected at the detection points are added to form a composite signal, and conclusions on a periodic structure of the textile material are drawn on the basis of temporal changes in the composite signal.

In a preferred embodiment, several groups of several respective discrete detection points are made available, wherein the detection points are equidistant within each group and the equidistances of the different groups are different. The detected scanning signals are added to form a composite signal in each group, and as a result of temporal changes in the individual composite signals periodic fractions in the structure of the textile material are compared with each other. It is advantageous to automatically represent in a diagram the values of a quantity for the several groups which correspond to the temporal changes. In the diagram, each value is designated with the equidistance of the respective group and/or with a spatial frequency which substantially corresponds to the inverse value of the equidistance. The group of numbers lies, e.g., between 2 and 50, preferably between 5 and 20.

The number of detection points lies, e.g., between 5 and 500, preferably between 20 and 200.

All detection points can be situated on an equidistant grid. The equidistance of the grid is, e.g., between 0.1 mm and 10 mm.

In a preferred embodiment, the scanning at the detection points occurs optically. In this case, the composite signal can be a sum total of intensities of light fractions detected at the detection points. The intensities can be added by means of merging optical waveguides.

A velocity of the textile material can be determined in that a prevalent time frequency is determined in the composite signal and that the velocity is calculated as a product from the time frequency and the equidistance of the detection points.

The device in accordance with the invention for detecting a periodic structure in a moving elongated textile material contains a substrate with several discrete detection points for the simultaneous optical scanning of the textile material, which detection points are arranged along the longitudinal direction of the textile material and are spaced in an equidistant manner from each other. An optical waveguide structure for merging light fractions detected at the detection points and for guiding the merged light fractions to an outcoupling interface arranged for outcoupling light from the optical waveguide structure is integrated on the substrate.

An optical waveguide structure integrated on a substrate shall be understood in this specification as a monolithic waveguide structure accommodated in or on the substrate. The waveguide structure was originally produced on the substrate, e.g. by technologies such as photolithography and/or doping, which is in contrast to separate discrete waveguides which were put subsequently on a substrate. The integrated optical waveguide structure is inseparably connected to the substrate. It contains a plurality of transparent dielectric layers with different refractive indexes. Preferably, a core layer with a higher refractive index is embedded between a bottom and an upper layer with lower refractive indexes, so that light waves can be guided in the core layer. The waveguide structure can contain microstrip waveguides which guide light in one direction and/or flat thin-layer waveguides in which light can propagate in two directions. In addition to the waveguides, it can contain further passive and/or active integrated optical components such as lenses, beam splitters, reflectors, filters, amplifiers, light sources and/or light receivers.

The optical waveguide structure is preferably arranged in such a way that during the merging a sum total of intensities of the light fractions detected at the detection points is formed and the composite signal thus formed is guided to the outcoupling interface.

The optical waveguide structure can comprise at least one junction with at least two branches. Furthermore, the optical waveguide structure can contain at least one waveguide for guiding light to the detection points.

The detection points are preferably provided with at least one respective focusing lens.

The outcoupling interface can be set up with an optical connecting part for connecting the waveguide structure. It is advantageous if the outcoupling interface is attached to an edge of the substrate.

In a preferred embodiment, several groups of several respective discrete detection points are arranged on the substrate. The detection points are equidistant within each group, wherein the equidistances of the different groups are different. The optical waveguide structure is arranged for merging light fractions respectively detected in each group and for guiding the individual merged light fractions to an outcoupling interface. The number of the groups lies between 2 and 50, preferably between 5 and 20.

In the present specification, the expressions such as “light” or “illuminating” are not only used for visible light, but also for electromagnetic radiation from the adjacent spectral ranges of ultraviolet (UV) and infrared (IR).

### BRIEF DESCRIPTION OF THE DRAWINGS

The invention is explained below in closer detail by reference to the schematic drawings. The explanation is made on the basis of the preferred example of optical scanning. Other scanning principles can also be applied in the method in accordance with the invention.

FIGS. 1 and 2 schematically show two different embodiments of a device in accordance with the invention in top views;

FIG. 3 schematically shows an arrangement of detection waveguides of a further embodiment of the device in accordance with the invention in a top view;

FIG. 4 schematically shows two possibilities for arranging detection points;

FIG. 5 schematically shows two different textile materials in side views;

FIG. 6 shows in (a), (b) potential temporal curves of output signals of a light receiver, and (c) shows the output signal of FIG. 6 (b) after rectifying;

FIG. 7 shows a spatial spectrum of a textile material obtained in accordance with the invention;

FIG. 8 schematically shows an end of an optical waveguide, a textile material to be examined and light beams extending in between in a top view;

FIG. 9 schematically shows a further embodiment of a device in accordance with the invention in a perspective view.

### DETAILED DESCRIPTION OF THE PREFERRED EMBODIMENTS

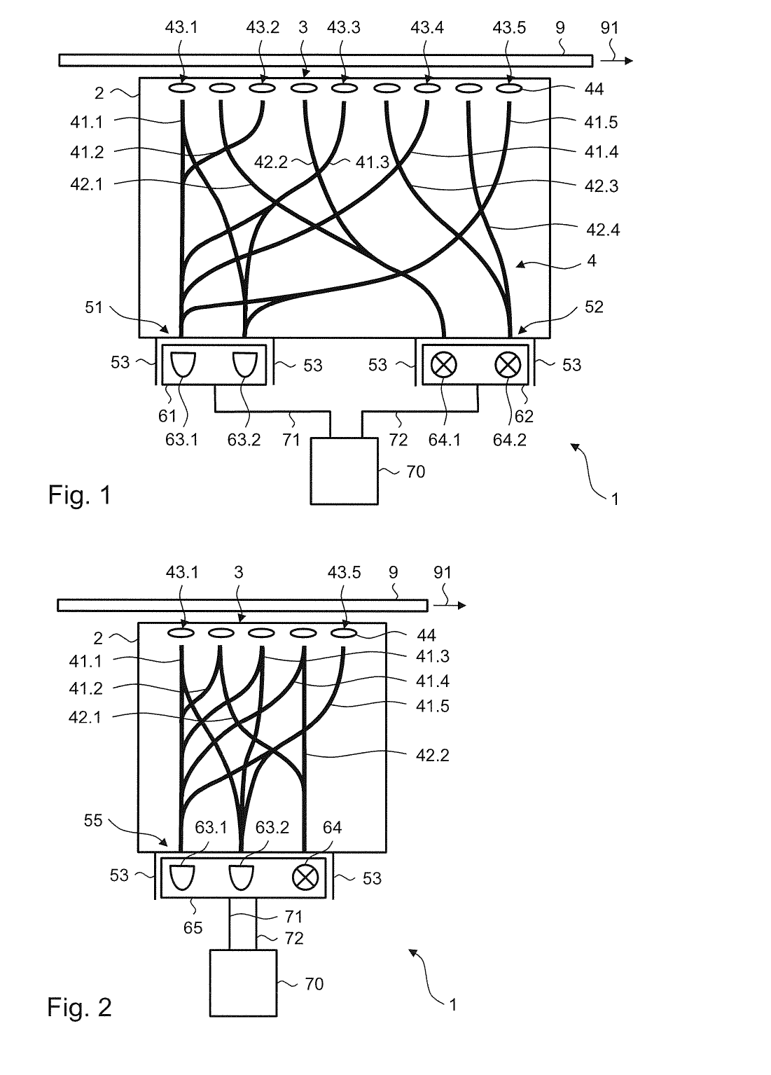

FIG. 1 shows a first embodiment of a device 1 in accordance with the invention. The device 1 is used for testing an elongated textile material 9 such as a yarn which is moved through or past the device 1. The direction of movement of the textile material 9 coincides with a longitudinal axis of the textile material 9 and is indicated in FIG. 1 by an arrow 91. The device 1 contains a substrate 2, on which a scanning region 3 is provided for the optical scanning of the textile material 9. The substrate 2 can consist of a known material such as glass, a synthetic material, a semiconductor material or a glass fiber mat impregnated with epoxy resin. It is preferably flat and rigid, i.e. it practically does not deform. The longitudinal axis and the direction of movement 91 of the textile material 9 lie in the plane of the substrate 2, but outside the substrate 2. The scanning region 3 coincides with a part of a side of the rectangular substrate 2, and is arranged in a straight and parallel manner to the longitudinal axis 91 of the textile material 9.

Several discrete detection points 43.1 to 43.5 for optically scanning the textile material 9 are arranged in the scanning region 3 in direct vicinity to the textile material 9 or its path, which detection points are arranged in an equidistant manner along the longitudinal direction 91 of the textile material 9. The light which interacts with the textile material, e.g. is reflected scattered thereon, is simultaneously detected at each detection point 43.1 to 43.5. The number of detection points lies, e.g., between 5 and 500, preferably between 20 and 200.

An optical waveguide structure 4 for merging light fractions detected at the detection points 43.1 to 43.5 and for guiding the merged light fractions to an outcoupling interface 51 is integrated on the substrate 2. In the embodiment of FIG. 1, the waveguide structure 4 contains nine optical microstrip waveguides 41.1 to 41.5, 42.1 to 42.4. The waveguide structure 4 can be made of a polymer for example, which is sufficiently transparent for the used light wavelength. It is preferably applied by a photolithographic process to the substrate 2. The transverse dimensions (width and height) of an individual waveguide 41.1 to 41.5, 42.1 to 42.4 can be between 5 μm and 500 μm, preferably approximately 50 μm. The waveguide structure 4 can be situated on an outermost layer of the substrate 2, or form an inner layer which is covered by at least one layer situated on top. In the latter case, the layer on top can protect the waveguide structure 4 from mechanical damage, soiling and undesirable optical influences. The waveguides 41.1 to 41.5, 42.1 to 42.4 can be arranged as single-mode or as multimode waveguides.

The waveguide structure 4 of FIG. 1 comprises several crossings of waveguides 41.1 to 41.5, 42.1 to 42.4. Notice shall be taken that crosstalk from the one to the other waveguide is prevented at these crossings. The person skilled in the art of integrated optics is capable of designing the waveguide structure 4 in such a way that this condition is sufficiently fulfilled. This can especially be the case when the respective crossing angle is close to 90° or is at least not too acute. In addition, the waveguide structure 4 of FIG. 1 contains junctions such as Y-junctions. The junctions can be arranged as known junction components. 1×2 junctions or junctions of a higher order can be concerned, as shown in the example of FIG. 1. The optical waveguide structure 4 can contain further integrated-optical components in addition to the waveguides per se, the crossings and the junctions. They can be passive and/or active. Examples such integrated-optical components are lenses, beam splitters, reflectors, filters, amplifiers, light sources and/or light receivers. Furthermore, optical elements such as light sources and/or light receivers can be applied as separate, discrete components to the substrate 2.

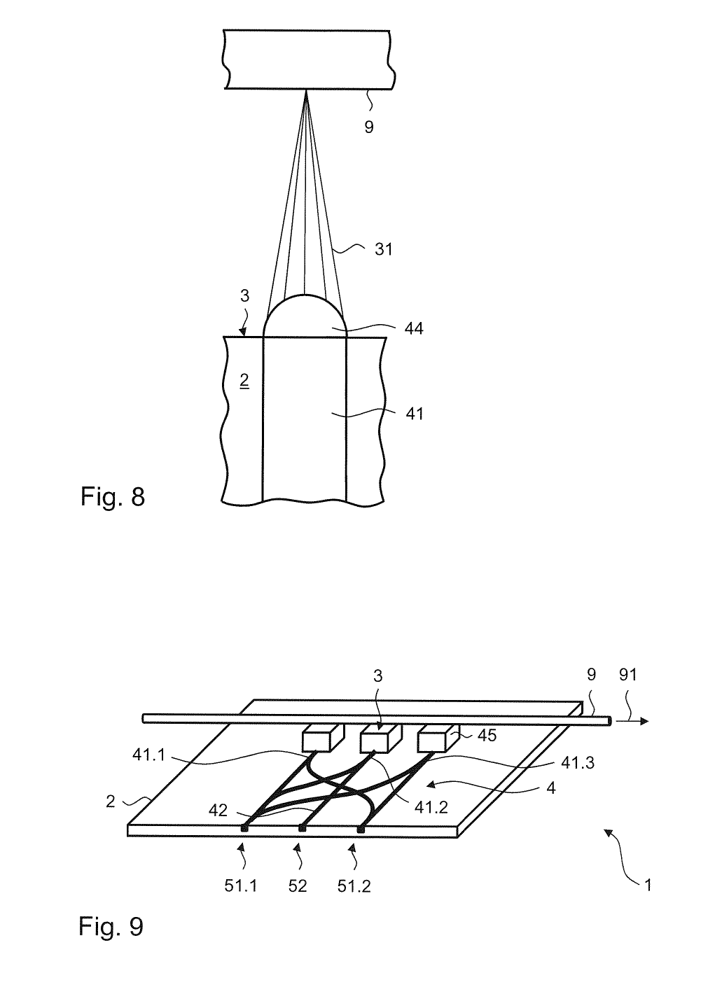

Light-collecting elements 44 such as focusing lenses can be attached to the orifices of the waveguides 41.1 to 41.5, 42.1 to 42.4 to the scanning region 3, preferably situated on a straight line, in order to ensure the highest possible light yield. As is known, light exiting from the end of a thin waveguide is emitted in a large beam angle. In temporal reversal, light from the same large beam angle is also incoupled into the waveguide. Since the textile material 9 to be examined usually has a small diameter of less than 1 mm, it would be struck by merely a small portion of the available light without countermeasures, and from said light only a small part would be incoupled into a waveguide again. The focusing lenses 44 are used to avoid such losses of light. Their function and their configuration are explained below in closer detail by reference to FIG. 8.

Four of the eight waveguides 41.1 to 41.5, 42.1 to 42.4, which are designated below as “illumination waveguides” 42.1 to 42.4, are used for illuminating the textile material 9. For this purpose, they receive light from an emitter module 62 and guide it to the scanning region 3, where it exits from the illumination waveguides 42.1 to 42.4 and impinges on the textile material 9 at least in part. The emitter module 62 can be attached to the end of a second electrical conductor 72. The light transfer from the emitter module 62 to the illumination waveguides 42.1 to 42.4 occurs on an incoupling interface 52 which is attached to an edge of the substrate 2. The incoupling interface 51 can be arranged as a plug-in connection for example. The emitter module 62 contains light sources 64.1, 64.2 which are arranged adjacently in a row for example. The light sources 64 can be arranged as diode lasers or light-emitting diodes for example. The incoupling of the light from the light sources 64.1, 64.2 into the illumination waveguides 42.1 to 42.4 can occur by direct illumination of the ends of the illumination waveguides or by means of optical elements such as mirrors and/or focusing lenses 44. In the latter case, similar lenses can be used as in the orifice to the scanning region 3. It is advantageous if the light emitted from the illumination waveguides 42.1 to 42.4 is not focused on a small point on the textile material 9, but illuminates a longer section of the textile material 9. It is important for ensuring effective incoupling of the light into the illumination waveguides 42.1 to 42.4 at the incoupling interface 52 that the light sources 64.1, 64.2 are positioned as precisely and as stable as possible with respect to the ends of the illumination waveguides. For this purpose, mechanical positioning means 53 for positioning the emitter module 62 with respect to the substrate 2 are attached to the incoupling interface 51. The positioning means 53 can be arranged as suitable guides for example, which ensure precise positioning within the plug-in connection. They are merely schematically indicated in FIG. 1, like the other elements.

The other five of the nine waveguides 41.1 to 41.5, 42.1 to 42.4 are used for detecting the light reflected from the textile material 9, and are therefore designated below as “detection waveguides” 41.1 to 41.5. They guide the light coming from the detection points 43.1 to 43.5 to a receiver module 61, which can be attached to the end of a first electric conductor 71. The light transfer from the detection waveguides 41.1 to 41.5 to the receiver module 61 occurs at an outcoupling interface 51 which is attached to an edge of the substrate 2. The outcoupling interface 51 can also be arranged as a plug-in connection with respective positioning means 53. The receiver module 61 contains light receivers 63.1, 63.2 which are arranged in a row adjacent to each other for example and each of which is assigned to a group of detection waveguides 41.1 to 41.5. The row of light receivers can be arranged as a CCD array for example. It is also possible to combine several receiver elements situated adjacent to each other, which then form an “assembled light receiver”. Concerning light outcoupling and the positioning and arrangement of the outcoupling interface 51, the same applies as already mentioned analogously with respect to the incoupling interface 52.

The junctions in the waveguide structure 4 are used for dividing light emitted by a single light source 64.1 and for supplying said light to several illumination waveguides 41.2, 41.4, and for merging light guided by several detection waveguides 41.1 to 41.5 and for supplying said light to a single light receiver 63.1. Especially the latter function, i.e. the addition of several scanning signals, is important for the present invention. As a result, several groups of several respective discrete detection points 43.1 to 43.5 can be formed, wherein the detection points 43.1 to 43.5 are equidistant within each group and the equidistances of the different groups are different. In each group, the detected scanning signals are added to form a composite signal and, as a result of temporal changes in the individual composite signals, the periodic fractions in the structure of the textile material 9 are compared with each other. In the embodiment of FIG. 1, all detection points 43.1 to 43.5 form a first group. The light fractions detected at the detection points 43.1 to 43.5 of the first group are added in the detection waveguides 41.1 to 41.5 form a composite signal and supplied to the first light receiver 63.1. Light however is supplied to a second light receiver 63.2, which light was detected at every other detection point 43.1, 43.3, 43.5, was guided by every other detection waveguide 41.1, 41.3, 41.5 and was subsequently added. The latter mentioned detection points 43.1, 43.3, 43.5 form a second group whose equidistance is twice as large as that of the first group.

The receiver module 61 and the emitter module 62 are connected via the first electrical conductor 71 and the second electrical conductor 72 to an electronic unit 70. It triggers the emitter module 62 on the one hand, and on the other hand the electronic unit 70 receives signals from the receiver module 61, evaluates them itself or conducts them, after optional preprocessing, to an evaluation unit (not shown).

It is advantageous to precisely define the outcoupling interface 51 and the incoupling interface 52 in an optical and mechanical manner and to thus quasi standardize them. As a result, the receiver module 61 and the emitter module 62 with their relatively expensive optoelectronic components can then be used without any changes for various substrates 2. On the other hand, the relatively inexpensive substrates 2 with their integrated optical waveguide structures 4 can be exchanged as required. There may be a need for exchanging a substrate 2 for example when a different waveguide structure 4 (especially in the scanning region 3) is needed or when a substrate 2 is damaged by wear and tear or is defective for other reasons.

The device 1 in accordance with the invention is preferably housed in a housing as known for example from U.S. Pat. No. 5,768,938 A. Such a housing was not included in the enclosed drawings for reasons of clarity of the illustration.

FIG. 2 shows a second embodiment of the device 1 in accordance with the invention. It is simplified with respect to the first embodiment of FIG. 1 in the respect that two waveguide ends facing the scanning region 3 are used both for illumination and also for detection. The respective focusing lenses 44 must be configured as a compromise in such a way that the illumination light illuminates the longest possible section of the textile material 9 and the detection light originates from the shortest possible section of the textile material 9. The junctions are arranged in such a way that a major portion of the light emitted by the light source 64 is emitted to the scanning region 3, and that a major portion of the light received from the scanning region 3 is supplied to the light receivers 63.1, 63.2. The person skilled in the art of integrated optics is capable of producing such junctions with knowledge of the invention. Furthermore, only one single optical interface 55 is present, which is used both as an incoupling and also as an outcoupling interface. In the respective transmitter and receiver module 65 there are therefore both two light receivers 63.1, 63.2 and also a light source 64.

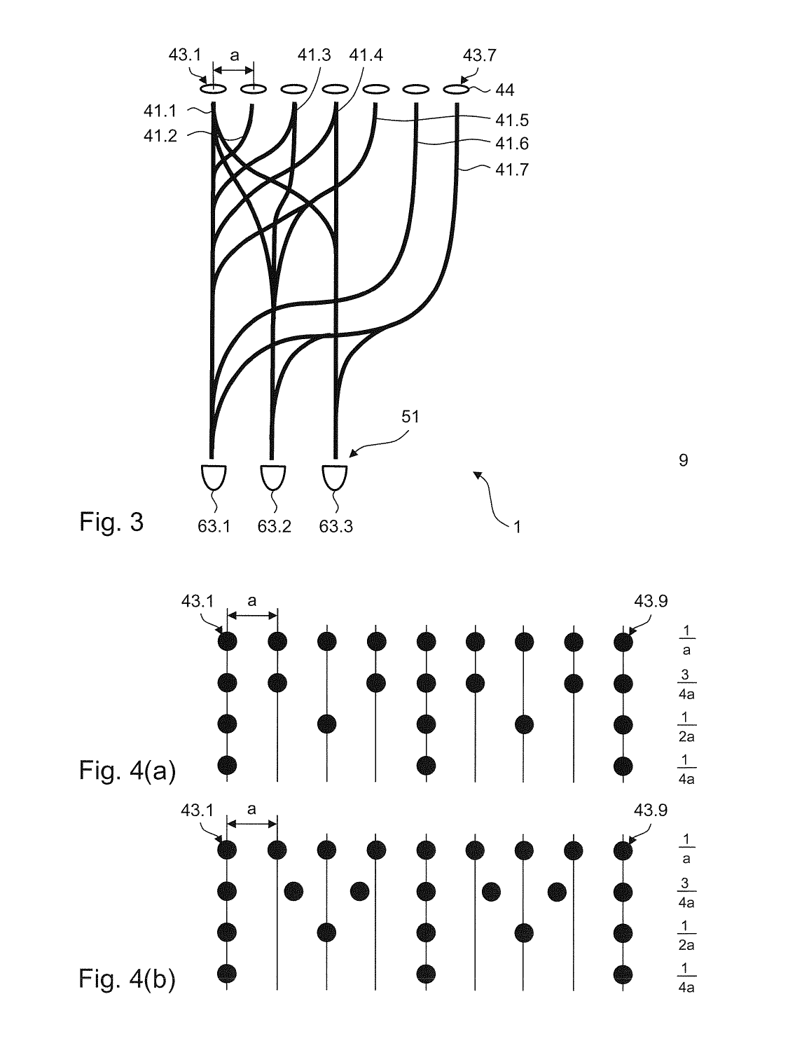

FIG. 3 shows a third embodiment of the device 1 in accordance with the invention, wherein only a number of important optical elements are shown for reasons of simplicity, namely the detection points 43.1 to 43.7 with the focusing lenses 44, the detection waveguides 41.1 to 41.7 of the waveguide structure 4 and the light receivers 63.1 to 63.3 on the outcoupling interface 51. Further elements such as illumination waveguides, substrate, transmitter and receiver module etc. can also be arranged in a manner similar to FIGS. 1 and 2, or in a different way. The embodiment of FIG. 3 comprises three light receivers 63.1 to 63.3 for example. The waveguide structure 4 with its junctions is arranged in such a way that the following functions are realized:
A first light receiver 63.1 is supplied with the sum total of all light components detected at all detection points 43.1 to 43.7. These detection points 43.1 to 43.7 form a first group.
The sum total of light components detected at every other detection point 43.1, 43.3, 43.5, 43.7 is supplied to a second light receiver 63.2. These detection points 43.1, 43.3, 43.5, 43.7 form a second group.
The sum total of light components detected at every third detection point 43.1, 43.4, 43.7 is supplied to a third light receiver 63.3. These detection points 43.1, 43.4, 43.7 form a third group.

The number of only seven detection points 43.1 to 43.7 and only three light receivers 63.1 to 63.3 is small and was chosen in FIG. 3 only for reasons of clarity of the illustration. A respectively higher number of detection points and a higher number of light receivers will be selected in practice and the waveguide structure 4 will be arranged accordingly. The number of the detection points lies between 5 and 500 for example, preferably between 20 and 200, and the number of the light receivers lies between 2 and 50 for example, preferably between 5 and 20.

FIG. 3 illustrates an important aspect of the invention. Several groups of several respective discrete detection points are provided, wherein the detection points within each group are equidistant and the equidistances of the different groups are different. The detected scanning signals are added to form a composite signal in each group. As a result of temporal changes in the individual composite signals, periodic fractions in the structure of the textile material 9 are compared with each other (see FIGS. 1 and 2). The receivers 63.1 to 63.3 emit signals from which a spatial frequency spectrum of the structure of the textile material can be determined in a simple way. If a is the constant distance (equidistance) of two respective detection points 43.1, 43.2 along the longitudinal axis 91 of the textile material 9, the spatial frequencies 1/a, 1/(2a), 1/(3a), . . . can be determined by means of the device 1 in accordance with the invention, as outlined in FIG. 3 (or with its generalization with more than three groups). In this sequence of spatial frequencies, the intervals decrease monotonically. Such a non-arithmetic sequence of spatial frequencies can be advantageous because its terms are rarely integral multiples of another term and thus higher harmonics do not generate any undesirable artifacts. This condition is fulfilled even better and furthermore an arithmetic sequence is approached if only higher terms are considered, e.g. 1/(11a), 1/(12a), 1/(13a), . . . The equidistance a is between 0.1 mm and 10 mm for example.

If equal intervals, i.e. an arithmetic sequence, are desired in the spatial frequency sequence, there are different possibilities, of which two are shown in FIG. 4. In these schematic illustrations, only the detection points 43.1 to 43.9 which are still active in the respective case are symbolized with points. Furthermore, a grid is entered with the period a for the detection points 43.1 to 43.9. The respective spatial frequencies are indicated on the right for the different cases. A “uniform cell” of the grid consists of eight equidistant positions for the detection points 43.1 to 43.8, so that the spatial frequencies 1/a, 1/(2a) and 1/(4a) can be detected easily. A problem is posed by the spatial frequency 3/(4a) to be detected. In the solution according to FIG. 4(a), the detection points are left on the grid and an approximation is made for the spatial frequency 3/(4a), in that every fourth detection point does not contribute to the summation. The second solution according to FIG. 4(b) deviates from the predetermined grid in order to enable precise detection of the spatial frequency 3/(4a). Both solutions presented in FIG. 4 solve the object of generating the arithmetic spatial frequency sequence 1/a, 3/(4a), 1/(2a) and 1/(4a). Both have respective advantages and disadvantages.

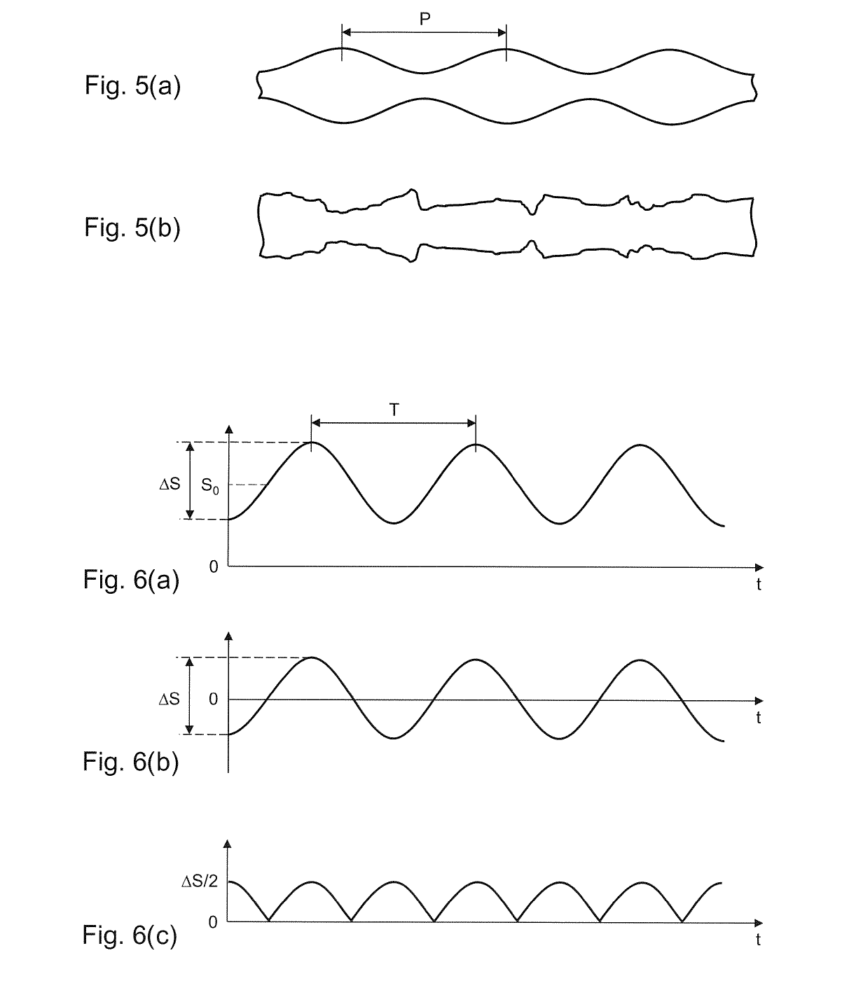

The schematic side views of elongated textile materials 9 (e.g. yarns) of FIG. 5 are needed below in order to better explain the invention. The textile material 9 of FIG. 5(a) has a distinct periodic structure with a spatial period P. For example, a diameter of the textile material 9 can change periodically with the longitudinal position. In contrast thereto, no spatial period can be recognized in the textile material of FIG. 5(b). When detecting light which was reflected or scattered on a short (e.g. in comparison with the spatial period P or another structural feature of the textile material 9) section of the textile material 9, the light intensity detected at a detection point is a measure for the diameter of the textile material 9. When detecting light which was transmitted past a short (in comparison with the spatial period P or any other structural feature of the textile material 9) section of the textile material 9, the detected light intensity is an inverse measure for the diameter of the textile material 9, i.e. the lower the light intensity the larger the diameter.

FIG. 6(a) shows a possible progression of an output signal of a light receiver 63.1, as shown for example in FIG. 3, against time t. If the spatial period P of the textile material 9 (see FIG. 5 (a)) coincides with the equidistance a of two detection points 43.1, 43.2 and the movement velocity of the textile material 9 is constant, the output signal is temporarily periodic with a time period T. The output signal shown in FIG. 6(a) has a steady component So in addition to the periodic alternating component of the amplitude ΔS. Said steady component So can be eliminated by a differential arrangement of detection points as disclosed in EP-1′553′037 A1. Two groups of equidistant detection points with the same equidistance a are needed for such a differential arrangement, which groups are mutually offset by half the equidistance a/2 in the running direction 91 of the textile material 9. The output signal of the second group is subtracted from the output signal of the first group. This produces the output signal shown in FIG. 6(b). It can be rectified, thus producing the signal according to FIG. 6(c).

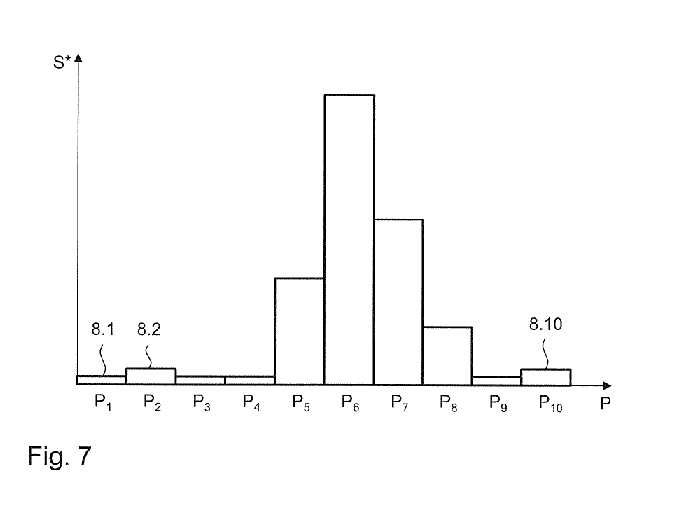

In a further processing step, the signal according to FIG. 6(c) can be integrated over an integration time which is long in comparison with the time period. The magnitude of the integral is a measure for a possible periodicity of the textile material 9 with the spatial period P=a. A comparison of several such integrals for different equidistances a (or spatial periods P) produces a spatial spectrum of the textile material 9 (see FIG. 7). In other words, the method and the device 1 in accordance with the invention supply a Fourier spectrum of the structure of the textile material 9 in a simple way.

The steady component S₀ of the output signal according to FIG. 6(a) can also be eliminated in a manner that differs from a differential arrangement of detection points, e.g. by subtraction of a current mean value of the output signal. Instead of the aforementioned integration, maximum value formation or a similar operation can be used which is a measure for the amplitudes ΔS of the signals according to FIG. 6(a) or 6(b). The aforementioned operations such as subtraction, rectification, integration or maximum value formation can be performed with analog and/or digital means. Both types of means and the respective signal converters are currently well-known. Such means can be housed in the electronic unit 70 is shown in FIGS. 1 and 2 for example, and/or in an evaluation unit connected to the electronic unit 70.

FIG. 7 shows a spatial spectrum as can be obtained from the method or the device 1 in accordance with the invention. A device 1 with ten light receivers is assumed, which are respectively assigned to a column 8.1 to 8.10 of the diagram, e.g. according to the following rules:
A first column 8.1 on the left edge of the diagram is assigned to the light receiver which is supplied with light from all existing detection points. It thus corresponds to the shortest spatial period P₁ (i.e. the highest spatial frequency) which can be determined in the textile material.
A second column 8.2 corresponds to the second shortest spatial period P₂ (i.e. its second highest spatial frequency) which can be determined in the textile material.
Et cetera.
A tenth column 8.10 on the right edge of the diagram corresponds to the longest spatial period P₁₀ (i.e. the lowest spatial frequency) which can be determined in the textile material.

The height S* of a column 8.1 to 8.10 is a measure for the amplitude ΔS of the light intensity received by the respective light receiver. It can correspond to the aforementioned integral value for example. The heights of the columns are preferably converted into normalized values, wherein it is taken into account that in the case of homogeneous illumination of all detection points the received light intensities would differ in strength.

In the spatial spectrum of FIG. 7, a maximum can be observed in the spatial period P₆. This means that the examined textile material 9 has a periodic structure with the spatial period P≈P₆ (cf. FIG. 5(a)). If required, the spatial period P can be determined even more precisely by means of respective statistical methods which are known to the person skilled in the art, by taking into account the finite heights of the adjacent columns 8.4 to 8.8. There can be textile materials 9 in which the method in accordance with the invention supplies two or more spatial periods or spatial frequencies. In the case of other textile materials 9, such as the one of FIG. 5(b), the columns 8.1 to 8.10 can all have approximately the same similar height, which means that no distinct spatial period or spatial frequency was determined.

The diagram shown in FIG. 7, or a similar diagram, is preferably automatically calculated from the composite signals and displayed on an output unit (not shown) of the device in accordance with the invention, e.g. a screen.

A velocity of the textile material 9 in the direction of movement 91 can also be determined by the present invention. For this purpose, an equidistance P of a group of detection points is preferably selected, which belongs to a spatial period P occurring in the spatial spectrum with large amplitudes, i.e. P=P₆ in the example of FIG. 7. In the composite signal, which belongs to this group of detection points, a predominant time frequency f is determined, i.e. f=1/T in the example of FIG. 6(a). The yarn velocity v is the product of the spatial period P and the time frequency f:

v=f·P=P/T.

Velocity measurement is also possible if no maximum can be determined in the spatial spectrum. An arbitrary group of detection points is then selected, whose amplitude in the spatial spectrum is unequal to zero. A predominant time frequency f is then determined again in the composite signal which belongs to this group of detection points. The velocity v is calculated according to the above formula.

An end of a waveguide 41 integrated on substrate 2 is schematically shown in FIG. 8 in a strongly enlarged manner, which end faces the scanning region 3. It is irrelevant whether an illumination waveguide or a detection waveguide is concerned, because both cases converge into each other by time reversal. The waveguide end is provided with a focusing lens 44. The focusing lens 44 can be made from the waveguide end itself, be glued directly thereon or be spaced therefrom. It is configured and arranged in such a way that it allows the largest possible quantity of light 31 emitted from the waveguide 41 to impinge on the textile material 9 or injects the largest possible quantity of light 31 coming from the text material 9 into the waveguide 41. A single focusing lens 44 is schematically shown in FIG. 8, but in practice said lens can be arranged as a lens system. The person skilled in the art of technical optics is capable with knowledge of the invention to determine and use an arrangement suitable for the described purpose.

FIG. 9 shows a ninth embodiment of the device 1 in accordance with the invention, in which the longitudinal axis 91 of the textile material 9 is situated parallel to the plane of the substrate 2, but is spaced therefrom. As a result, the textile material 9 is moved above the substrate 2 along its longitudinal direction 91 of the textile material 9. The scanning region 3 lies in or above the plane of the substrate 2. Light which is guided by means of an illumination waveguide 42 from an incoupling interface 52 to the scanning region 3 is outcoupled in the scanning region 3 towards the textile material 9. After interaction with the textile material 9, e.g. reflection and/or scattering on the same, at least a portion of said light is incoupled into the detection waveguides 41.1 to 41.3 and guided therefrom to the outcoupling interfaces 51.1, 51.2. Optical coupling elements 45 are required in this embodiment for incoupling and outcoupling the light in the scanning region 3, which coupling elements are capable of outcoupling light out of the plane of the substrate 2 or incoupling said light from the outside into a waveguide 41.2 to 41.3 integrated on the substrate 2. Such coupling elements 45 are known and need not be discussed here in closer detail. The coupling elements 45 can additionally be equipped with focusing lenses and other optical components. The emitter module and the receiver module, the conductors and the electronic unit are not shown in FIG. 9 for reasons of simplicity of the illustration. They can be arranged in the same way or similarly to FIG. 1 or 2.

The scanning at the detection points can occur optically, electrically and/or a based on a different physical principle. In embodiments which are not shown here, electrical circuits can be integrated on the substrate 2 instead of or in addition to the optical waveguide structure 4, as known from the field of electronics. Such circuits can contain passive and/or active electrical components in addition to electrical conductor paths. Examples for such electrical components are resistors, capacitors, coils, transistors, filters and amplifiers. Complex components such as microprocessors can also be situated on the substrate 2, wherein they are preferably applied to the substrate 2 as integrated circuits in a separate housing. The electrical conductor paths can open into the scanning region 3, wherein the orifices are preferably provided with electrodes. The electrodes are used to produce and/or detect an electrical field, preferably an alternating electrical field, in the scanning region 3. The textile material 9 interacts with the electrical field and influences it. The electrical testing of the textile material 9 is based on detecting the influences of the textile material 9 on the electrical field and to draw conclusions therefrom on the physical properties of the textile material 9. The capacitive testing of textile material 9 is sufficiently known from the state of the art. Similar to the optical interface 55 and the optical transmitter and receiver module 65 (cf. FIG. 2), the device 1 in accordance with the invention can be provided with an electrical interface and an electrical connecting part. The electrical interface can be arranged as a plug-in connection, as relevantly known from electronics and available on the market.

Both an optical waveguide structure and also an electrical conductor structure can be integrated on the same substrate 2 in embodiments of the device in accordance with the invention (not shown), wherein both structures open at least partly into the scanning region 3. This embodiment thus offers the possibility to test the textile material 9 in a selectively optical, electrical, or both optical and also electrical manner.

It is understood that the present invention is not limited to the embodiments as discussed above. With knowledge of the invention, the person skilled in the art will be able to derive further variants which also belong to the subject matter of the present invention. In particular, the discussed embodiments can be combined with each other in an arbitrary fashion. The number of light sources, light receivers, waveguides, detection points, ends of waveguides, lenses et cetera, which are used in the drawings by way of example, shall in no way be understood as limiting.

### LIST OF REFERENCE NUMERALS

1 Device

2 Substrate

3 Scanning region

31 Light beams

4 Optical waveguide structure

41 Detection waveguide

42 Illumination waveguide

43 Detection point

44 Focusing lens

45 Optical coupling element

51 Outcoupling interface

52 Incoupling interface

53 Mechanical positioning means

55 Optical interface

61 Receiver module

62 Emitter module

63 Light receiver

64 Light source

65 Transmitter and receiver module

70 Electronic unit

71, 72 Electrical conductors

8 Columns of the spatial spectrum

9 Textile material

91 Longitudinal axis and direction of movement of the textile material

1-24. (canceled)

25. A method for detecting a periodic structure in a moving elongated textile material, comprising:
simultaneously scanning the textile material at several discrete detection points arranged along its longitudinal direction and spaced in an equidistant manner from each other,
adding scanning signals detected at the detection points to form a composite signal, and
identifying temporal changes in the composite signal as indicative of a periodic structure of the textile material.

26. A method according to claim 25, wherein:
several groups of several respective discrete detection points are provided,
the detection points are equidistant within each group and the equidistances of the various groups are different,
the detected scanning signals are added to form a composite signal in each group, and
periodic fractions in the structure of the textile material are compared with each other on the basis of temporal changes in the individual composite signals.

27. A method according to claim 26, wherein the values of a quantity corresponding to the temporal changes for the several groups are automatically displayed in a diagram.

28. A method according to claim 27, wherein each value with at least one of the equidistance of the respective group and a spatial frequency which substantially corresponds to the inverse value of the equidistance is designated in the diagram.

29. A method according to claim 26, wherein the number of groups lies between 2 and 50.

30. A method according to claim 25, wherein the number of the detection points lies between 5 and 500.

31. A method according to claim 25, wherein the scanning at the detection points occurs optically.

32. A method according to claim 31, wherein the composite signal is a sum total of intensities of light fractions detected at the detection points.

33. A method according to claim 32, wherein the intensities are added up by means of merging of optical waveguides.

34. A method according to claim 25, wherein a velocity of the textile material is determined in that a predominant time frequency is determined in the composite signal and the velocity is calculated as the product of the time frequency and the equidistance of the detection points.

35. A device for detecting a periodic structure in a moving elongated textile material, comprising:
a substrate comprising
several discrete detection points, which are arranged along the longitudinal direction of the textile material and are spaced from each other in an equidistant manner, for the simultaneous optical scanning of the textile material, and
an optical waveguide structure integrated on the substrate for merging light fractions detected at the detection points and for guiding the merged light fractions to a outcoupling interface, which is arranged for outcoupling light from the waveguide structure.

36. A device according to claim 35, wherein the optical waveguide structure is arranged in such a way that during the merging a sum total of intensities of the light fractions detected at the detection points is formed and the composite signal thus formed is guided to the outcoupling interface.

37. A device according to claim 35, wherein the optical waveguide structure comprises at least one junction with at least two branches.

38. A device according to claim 35, wherein the optical waveguide structure contains at least one waveguide for guiding light to the detection points.

39. A device according to claim 35, wherein the outcoupling interface is configured for connecting the waveguide structure to an optical connecting part.

40. A device according to claim 35, wherein several groups of several respective discrete detection points are arranged on the substrate, wherein the detection points are equidistant within each group and the equidistances of the different groups are different, and the optical waveguide structure is arranged for merging light fractions detected in each respective group and for guiding the individual merged light fractions to an outcoupling interface.

41. A device according to claim 40 wherein the number of groups lies between 2 and 50.

42. A device according to claim 35, wherein the number of detection points lies between 5 and 500.

43. A device according to claim 35, wherein all detection points lie on an equidistant grid.

44. A device according to claim 43, wherein the equidistance of the grid is between 0.1 mm and 10 mm.
